(19) United States
(12) Patent Application Publication
(10) Pub. No.: US 2025/0063475 A1
(43) Pub. Date: Feb. 20, 2025

(54) ON-DEMAND SS/PBCH BLOCK

(71) Applicant: Samsung Electronics Co., Ltd., Suwon-si (KR)

(72) Inventors: Hongbo Si, Allen, TX (US); Anil Agiwal, Allen, TX (US); Jeongho Jeon, San Jose, CA (US)

(21) Appl. No.: 18/793,578

(22) Filed: Aug. 2, 2024

Related U.S. Application Data
(60) Provisional application No. 63/532,816, filed on Aug. 15, 2023.
(60) Provisional application No. 63/533,034, filed on Aug. 16, 2023.
(60) Provisional application No. 63/631,701, filed on Apr. 9, 2024.

(51) Int. Cl. H04W 48/14

(52) U.S. Cl. CPC H04W 48/14

(57) ABSTRACT

Methods and apparatuses for an operation for an on-demand synchronization signals/physical broadcast channel (SS/PBCH) block is provided. A method of a user equipment (UE) in a wireless communication system includes determining a first set of parameters for a first set of SS/PBCH blocks and determining a second set of parameters for a second set of SS/PBCH blocks. The first set of parameters includes a first cell identity (ID) and a first frequency location. The second set of parameters includes a second cell ID and a second frequency location. The first set of SS/PBCH blocks is periodic. The second set of SS/PBCH blocks is on-demand and indicated to be transmitted by a base station (BS). The method further includes receiving a first SS/PBCH block from the first set of SS/PBCH blocks and receiving a second SS/PBCH block from the second set of SS/PBCH blocks.

### CROSS-REFERENCE TO RELATED APPLICATIONS AND CLAIM OF PRIORITY

The present application claims priority to:
U.S. Provisional Patent Application No. 63/532,816, filed on Aug. 15, 2023;
U.S. Provisional Patent Application No. 63/533,034, filed on Aug. 16, 2023; and
U.S. Provisional Patent Application No. 63/631,701, filed on Apr. 9, 2024. The contents of the above-identified patent documents are incorporated herein by reference.

### TECHNICAL FIELD

The present disclosure relates generally to wireless communication systems and, more specifically, the present disclosure relates to an on-demand synchronization signals/physical broadcast channel (SS/PBCH) block in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to an operation for on-demand SS/PBCH block in a wireless communication system.

In one embodiment, a user equipment (UE) in a wireless communication system is provided. The UE includes a processor configured to determine a first set of parameters for a first set of synchronization signals and physical broadcast channel (SS/PBCH) blocks and determine a second set of parameters for a second set of SS/PBCH blocks. The first set of parameters includes a first cell identity (ID) and a first frequency location. The second set of parameters includes a second cell ID and a second frequency location. The first set of SS/PBCH blocks is periodic. The second set of SS/PBCH blocks is on-demand and indicated to be transmitted by a base station (BS). The first cell ID is different from the second cell ID. The first frequency location is different from the second frequency location. The UE further includes a transceiver operably coupled to the processor. The transceiver is configured to receive a first SS/PBCH block from the first set of SS/PBCH blocks; and receive a second SS/PBCH block from the second set of SS/PBCH blocks.

In another embodiment, a method of a UE in a wireless communication system is provided. The method includes determining a first set of parameters for a first set of SS/PBCH blocks and determining a second set of parameters for a second set of SS/PBCH blocks. The first set of parameters includes a first cell ID and a first frequency location. The second set of parameters includes a second cell ID and a second frequency location. The first set of SS/PBCH blocks is periodic. The second set of SS/PBCH blocks is on-demand and indicated to be transmitted by a BS. The first cell ID is different from the second cell ID. The first frequency location is different from the second frequency location. The method further includes receiving a first SS/PBCH block from the first set of SS/PBCH blocks and receiving a second SS/PBCH block from the second set of SS/PBCH blocks.

In yet another embodiment, a BS in a wireless communication system is provided. The BS includes a processor configured to determine a first set of parameters for a first set of SS/PBCH blocks and determine a second set of parameters for a second set of SS/PBCH blocks. The first set of parameters includes a first cell ID and a first frequency location. The second set of parameters includes a second cell ID and a second frequency location. The first set of SS/PBCH blocks is periodic. The second set of SS/PBCH blocks is on-demand. The first cell ID is different from the second cell ID. The first frequency location is different from the second frequency location. The BS further includes a transceiver operably coupled to the processor. The transceiver is configured to transmit the first and second set of SS/PBCH blocks.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6 illustrates an example of SS/PBCH block structure according to embodiments of the present disclosure;

FIG. 7 illustrates an example of procedure for on-demand SSB/SIB1 according to embodiments of the present disclosure;

FIG. 8 illustrates a flowchart of UE method for distinguishing on-demand SS/PBCH block according to embodiments of the present disclosure;

FIG. 9 illustrates an example of on-demand SSB indication in DCI according to embodiments of the present disclosure; and

FIG. 10 illustrates a flowchart of UE method for handling collision with on-demand SSB(s) according to embodiments of the present disclosure.

### DETAILED DESCRIPTION

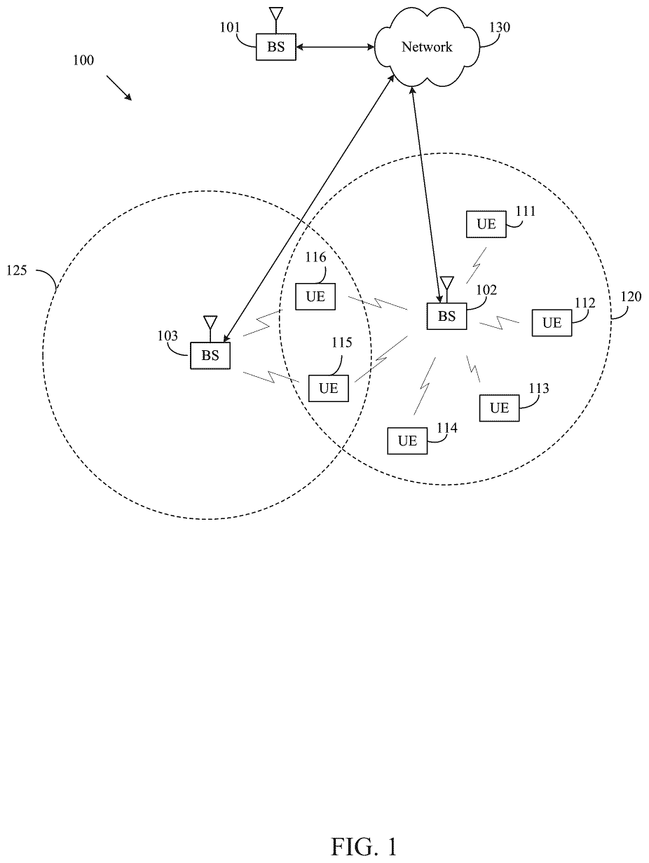

FIGS. 1-10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents are hereby incorporated by reference into the present disclosure as if fully set forth herein: 3GPP TS 38.211 v16.1.0, “NR; Physical channels and modulation”; 3GPP TS 38.212 v16.1.0, “NR; Multiplexing and channel coding”; 3GPP TS 38.213 v16.1.0, “NR; Physical layer procedures for control”; 3GPP TS 38.214 v16.1.0, “NR; Physical layer procedures for data”; and 3GPP TS 38.331 v16.1.0, “NR; Radio Resource Control (RRC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for an operation for on-demand SS/PBCH block in a wireless communication system. In certain embodiments, and one or more of the gNBs 101-103 includes circuitry, programing, or a combination thereof, for supporting an operation for on-demand SS/PBCH block in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

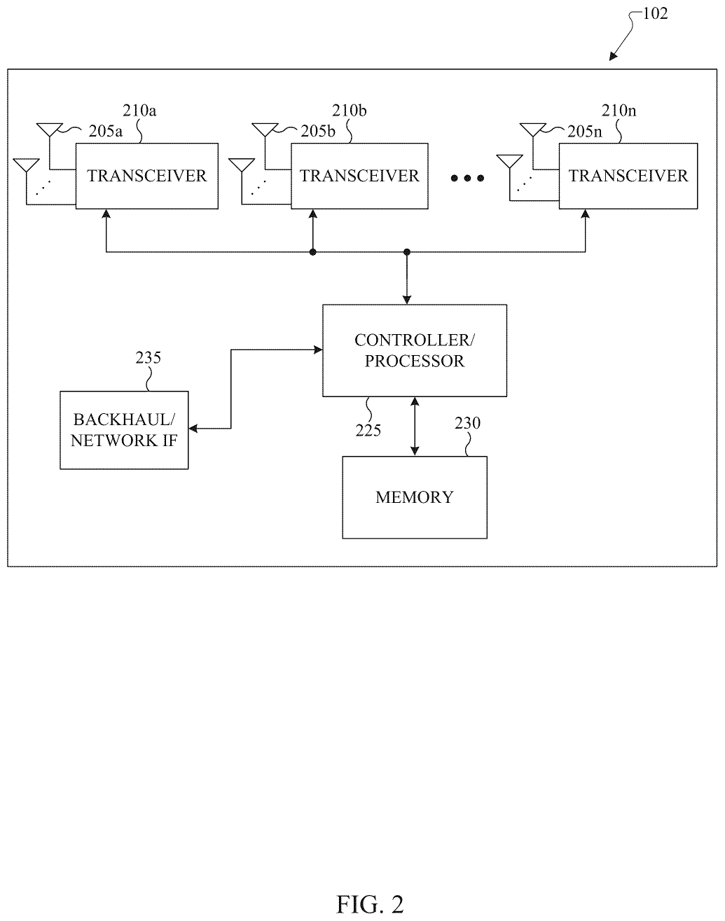

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for supporting an operation for on-demand SS/PBCH block in a wireless communication system. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

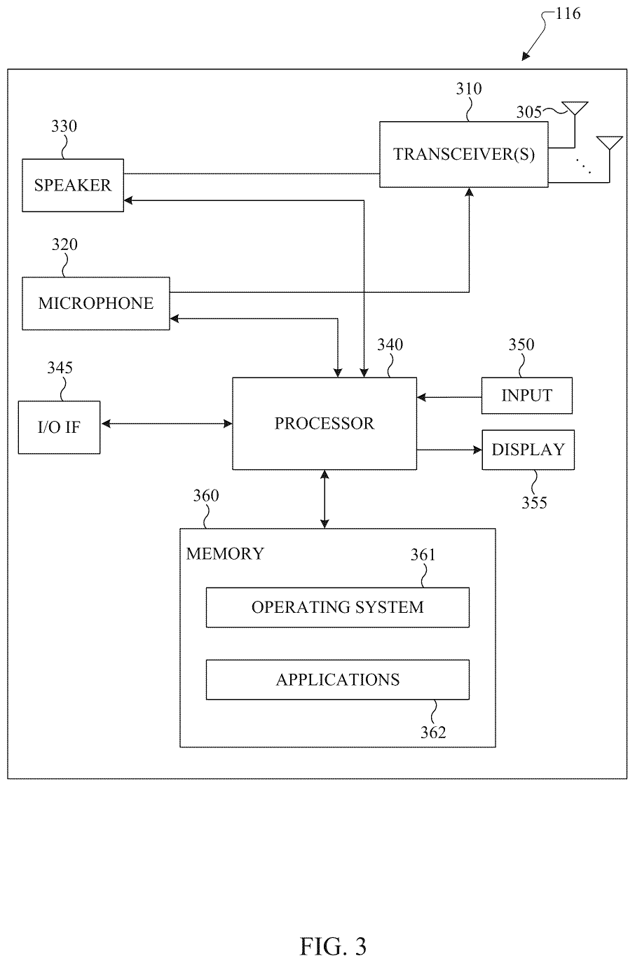

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for an operation for on-demand SS/PBCH block in a wireless communication system.

The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355 which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

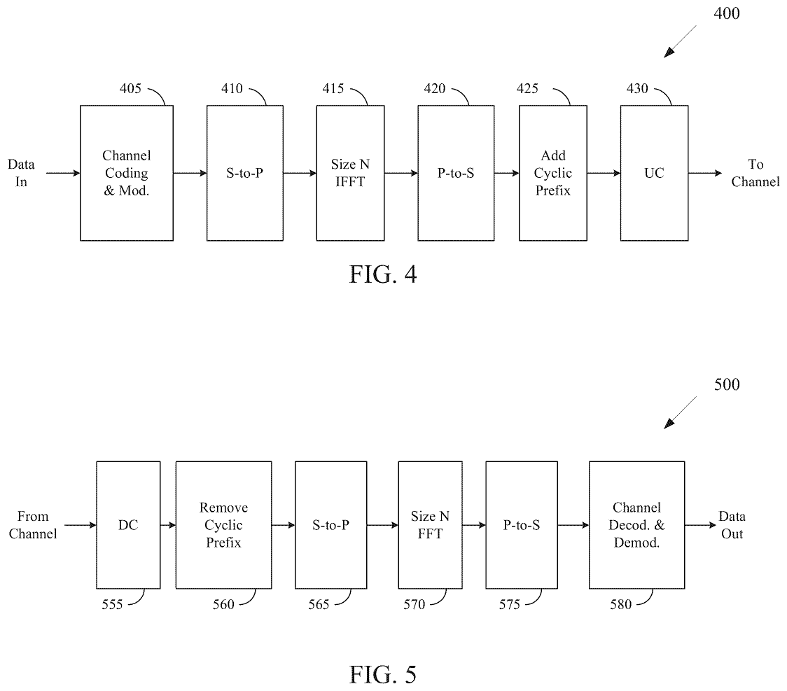

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support an operation for on-demand SS/PBCH block in a wireless communication system.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIGS. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

FIG. 6 illustrates an example of SS/PBCH block structure 600 according to embodiments of the present disclosure. An embodiment of the SS/PBCH block structure 600 shown in FIG. 6 is for illustration only.

NR supports synchronization through synchronization signals transmitted on downlink. A synchronization signals/physical broadcast physical channel block (SSB) compromises of four consecutive OFDM symbols in time domain (e.g., as illustrated in FIG. 6), wherein the first symbol is mapped for primary synchronization signal (PSS), the second and forth symbols are mapped for PBCH, and the third symbol is mapped for both secondary synchronization signal (SSS) and PBCH. The transmission bandwidth of PSS and SSS (e.g., 12 resource blocks (RBs)) is smaller than the transmission bandwidth of the whole SS/PBCH block (e.g., 20 RBs). In every RB mapped for PBCH, 3 out of the 12 resource elements (REs) are mapped for the demodulation reference signal (DMRS) of PBCH, wherein the 3 REs are uniformly distributed in the RB and the starting location of the first resource element (RE) (e.g., v as in TABLE 1) is based on cell ID.

TABLE 1
Resource mapping within a S-SS/PSBCH block.

| Signal or channel | Symbol index | Subcarrier index |
|---|---|---|
| S-PSS | 0 | 56, 57, . . . , 182 |
| S-SSS | 2 | 56, 57, . . . , 182 |
| Set to zero | 0 | 0, 1, . . . , 55, 183, 184, . . . , 239 |
| | 2 | 48, 49, . . . , 55, 183, 184, . . . , 191 |
| PSBCH | 1, 3 | 0, 1, . . . , 239 |
| | 2 | 0, 1, . . . , 47, |
| | | 192, 193, . . . , 239 |
| DM-RS for | 1, 3 | 0 + v, 4 + v, . . . , 236 + v |
| PSBCH | 2 | 0 + v, 4 + v, . . . , 44 + v, |
| | | 192 + v, 196 + v, . . . , 236 + v, |

An SS/PBCH block is transmitted on a cell periodically, with a periodicity configured by a gNB. As an always-present transmission, the power consumption for SS/PBCH block (SSB) in a cell can be significantly large. To reduce the power consumption, the periodicity of SSB can be large, which may result in long delay for receiving the SSB, if a UE needs to receive a SSB on a timing within the long period for SSB. For this purpose, on-demand SSB can be supported, e.g., in addition to the periodic SSB, to reduce the latency for receiving the SSB.

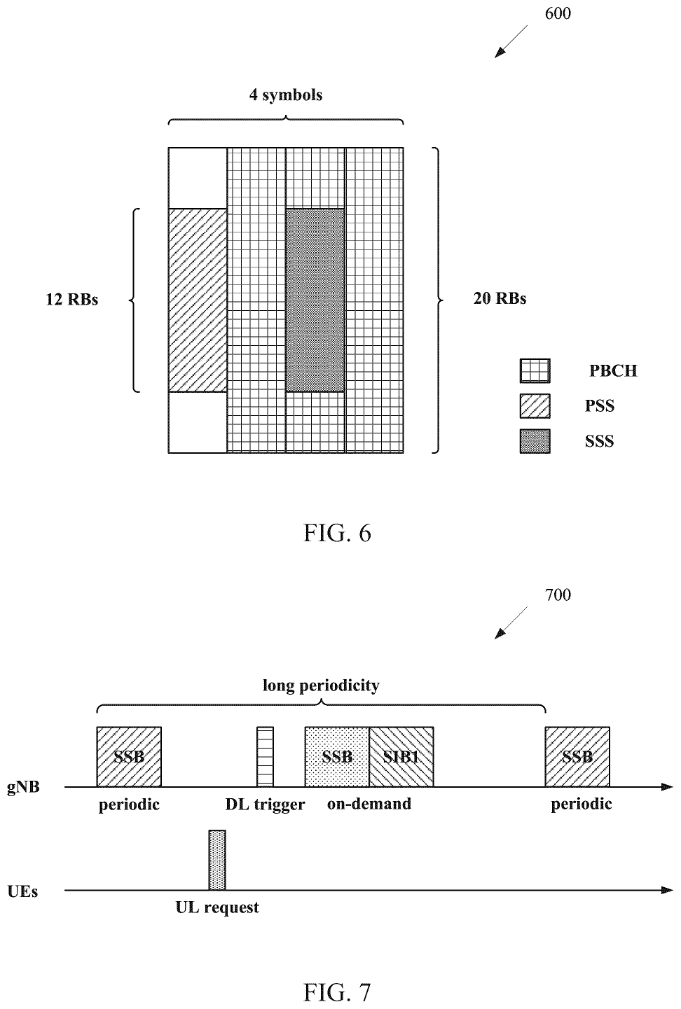

For this purpose, for example, a UE can transmit an uplink request for on-demand SSB and/or system information block 1 (SIB1), and the UE may receive a downlink trigger for the on-demand SSB and/or SIB1 before the reception of the on-demand SSB and/or SIB1. For this example, the procedure for uplink request and/or downlink trigger can be absent, in certain exemplified cases of this disclosure. An illustration of this example is shown in FIG. 7.

FIG. 7 illustrates an example of procedure for on-demand SSB/SIB1 700 according to embodiments of the present disclosure. An embodiment of the procedure for on-demand SSB/SIB1 700 shown in FIG. 7 is for illustration only.

From a UE perspective, there is a need to distinguish the on-demand SSB and legacy SSB (e.g., periodic). For one instance, for a legacy UE not supporting on-demand SSB, the existence of on-demand SSB could cause confusion when receiving the legacy SSB, e.g., in an initial access procedure. For another instance, for a UE supporting the on-demand SSB, the existence of the on-demand SSB could also cause confusion sometimes, e.g., missing or not knowing the DL trigger as in the initial access procedure.

From a UE perspective, there is a need to perform resource allocation based on the on-demand SSB, e.g., such that there is no confusion for determining the resources for receiving or transmitting other signals and channels.

The present disclosure focuses on a design to distinguish an on-demand SSB from a regular SSB. More precisely, the following components are included in the present disclosure.

In one example for distinguishing an on-demand SSB from a regular SSB, followings are provided: (1) cell identification (ID), (2) frequency location, (3) a primary synchronization signal (PSS), (4) a secondary synchronization signal (SSS), (5) a structure of SSB, (6) demodulation reference signal (DM-RS) of PBCH, (7) bits in the PBCH payload, (8) reserved bits or codepoint in PBCH payload, (9) a number of resource elements (Res) for PBCH, and (10) a time domain pattern. In another example, common components for on-demand SSB and legacy SSB are provided. In yet another embodiment, UE procedures are provided.

The present disclosure further focuses on a design to determine whether a UE may avoid collision with on-demand SSB when perform resource allocation for other signals or channels. More precisely, the following components are provided in the present disclosure: (1) a UE behavior to avoid collision with on-demand SSB; (2) a UE behavior not to avoid collision with on-demand SSB, (3) a criteria to determine whether to avoid collision with on-demand SSB, and (4) a UE procedure.

In one embodiment, a UE can distinguish an on-demand SSB from a legacy SSB using at least one of the following examples, wherein for example, a legacy SSB refers to SSB(s) with periodic transmission or burst (e.g., periodic SSB), and for example, an on-demand SSB refers to SSB(s) transmission or burst based on either gNB triggering or UE triggering (e.g., non-periodic SSB).

In one example, the UE assumes the cell ID of the on-demand SSB can be different from the cell ID of the legacy SSB.

For one instance, there can be a fixed relationship between the cell ID (denoted as N1) of the on-demand SSB and the cell ID (denoted as N2) of the legacy SSB, such as N1=N2+N, wherein N is a fixed integer.

For another instance, the cell ID of the on-demand SSB can be indicated to the UE by a gNB. For a further consideration, the indication can be a higher layer parameter, which is different from the one for the legacy SSB.

For yet another instance, the cell ID (denoted as N1) of the on-demand SSB and the cell ID (denoted as N2) of the legacy SSB can have the relationship N1=N2+N, wherein N is provided by a higher layer parameter.

For yet another instance, the cell ID of the on-demand SSB and the cell ID of the legacy SSB are from different value ranges (such as selected from two different set of cell IDs), e.g., a UE can determine the detected SSB is a legacy SSB (selected from a first set of cell IDs) or on-demand SSB (selected from a second set of cell IDs).

In another example, the UE assumes the frequency location of the on-demand SSB can be different from the frequency location of the legacy SSB, wherein for example, the frequency location refers to the center subcarrier of the SSB.

For one instance, there can be a fixed relationship between the frequency location (denoted as F1) of the on-demand SSB and the frequency location (denoted as F2) of the legacy SSB such as F1=F2+F, wherein F is a fixed value.

For another instance, there can be a relationship between the frequency location (denoted as F1) of the on-demand SSB and the frequency location (denoted as F2) of the legacy SSB, such as F1=F2+F, wherein F is provided by a higher layer parameter.

For yet another instance, the frequency location of the on-demand SSB can be indicated to the UE by a gNB, e.g., by an absolute frequency value (such as a ARFCN), or an offset comparing to the starting point of the common resource grid (such as an offset to Point A), or an offset comparing to the starting point of the BWP (such as the BWP including the on-demand SSB), or an offset comparing to the starting point of the carrier (such as the carrier including the on-demand SSB). For a further consideration, the indication can be a higher layer parameter, which is different from the one for the legacy SSB.

For yet another instance, the frequency location of the on-demand SSB and the frequency location of the legacy SSB are from different value ranges. For one example, when the frequency location of the legacy SSB is from a set of values defined as synchronization raster entries (e.g., for initial cell search purpose), then the frequency location of the on-demand SSB is not from the set of values defined as synchronization raster entries. For another one example, when the frequency location of the legacy SSB is provided by a first higher layer parameter, and the frequency location of the on-demand SSB is provided by a second higher layer parameter, then the first and second higher layer parameter are different (e.g., could be potentially a minimum value on the difference between the first and second higher layer parameter). For yet another one example, the on-demand SSB can be further determined to be not associated with a system information block 1 (SIB1), e.g., a non-cell defining SSB. For yet another example, it can be further assumed that the time (e.g., OFDM symbols) and/or frequency resources (e.g., RBs or REs) of the on-demand SSB do not overlap with the time (e.g., OFDM symbols) and/or frequency resources (e.g., RBs or REs) of the legacy SSB, e.g., in the same cell.

In yet another example, the UE assumes a PSS sequence of the on-demand SSB can be different from the PSS sequence of the legacy SSB.

For one instance, the PSS sequence for the on-demand SSB can use a generation function different from the one for the legacy SSB.

For one example, the generation function for the PSS sequence for the on-demand SSB can be given by x(i+7)=(x(i+1)+x(i)) mod 2.

For another example, the generation function for the PSS sequence for the on-demand SSB can be given by x(i+7)=(x(i+3)+x(i)) mod 2.

For yet another example, the generation function for the PSS sequence for the on-demand SSB can be given by x(i+7)=(x(i+6)+x(i)) mod 2.

For another instance, the PSS sequence for the on-demand SSB can use a cyclic shift different from the one for the legacy SSB.

For one example, the cyclic shift for the PSS sequence for the on-demand SSB can be given by m=(n+43·N_ID^(2)+K), wherein K is an integer, such as K=21, or K=22, or K=10, or K=11, or K=31, or K=32.

For yet another instance, the PSS sequence for the on-demand SSB can use an initial condition different from the one for the legacy SSB.

For one example, the initial condition for the PSS sequence for the on-demand SSB can be given by [x(6) x(5) x(4) x(3) x(2) x(1) x(0)]=[0000001].

For yet another instance, the PSS sequence for the on-demand SSB can use a different mapping order comparing to the one for the legacy SSB.

For one example, the modulated value d_PSS(0) is mapped to subcarrier #182 in the PSS symbol within the on-demand SSB, d_PSS(1) is mapped to subcarrier #181 in the PSS symbol within the on-demand SSB, and so on, till d_PSS(126) is mapped to subcarrier #56 in the PSS symbol within the on-demand SSB (i.e., d_PSS(k) is mapped to subcarrier #182-k in the PSS symbol within the on-demand SSB, wherein 0≤k≤126).

In yet another example, the UE assumes a SSS sequence of the on-demand SSB can be different from the SSS sequence of the legacy SSB.

For one instance, the SSS sequence for the on-demand SSB can use a set of generation functions different from the one for the legacy SSB.

For one example, the set generation functions for the SSS sequence for the on-demand SSB can be given by x0(i+7)=(x0(i+4)+x0(i)) mod 2 and x1(i+7)=(x1(i+3)+x1(i)) mod 2.

For another example, the set generation functions for the SSS sequence for the on-demand SSB can be given by x0(i+7)=(x0(i+4)+x0(i)) mod 2 and x1(i+7)=(x1(i+6)+x1(i)) mod 2.

For yet another example, the set generation functions for the SSS sequence for the on-demand SSB can be given by x0(i+7)=(x0(i+6)+x0(i)) mod 2 and x1(i+7)=(x1(i+1)+x1(i)) mod 2.

For yet another example, the set generation functions for the SSS sequence for the on-demand SSB can be given by x0(i+7)=(x0(i+3)+x0(i)) mod 2 and x1(i+7)=(x1(i+1)+x1(i)) mod 2.

For yet another example, the set generation functions for the SSS sequence for the on-demand SSB can be given by x0(i+7)=(x0(i+3)+x0(i)) mod 2 and x1(i+7)=(x1(i+6)+x1(i)) mod 2.

For yet another example, the set generation functions for the SSS sequence for the on-demand SSB can be given by x0(i+7)=(x0(i+6)+x0(i)) mod 2 and x1(i+7)=(x1(i+3)+x1(i)) mod 2.

For yet another example, the set generation functions for the SSS sequence for the on-demand SSB can be given by x0(i+7)=(x0(i+1)+x0(i)) mod 2 and x1(i+7)=(x1(i+4)+x1(i)) mod 2.

For another instance, the SSS sequence for the on-demand SSB can use a cyclic shift different from the one for the legacy SSB.

For one example, the cyclic shift for the SSS sequence for the on-demand SSB can be given by m0=1519 [N_ID^(1)/112]+5·N_ID^(2)+K0, wherein K0 is an integer, such as K0=2, or K0=3.

For yet another instance, the SSS sequence for the on-demand SSB can use an initial condition different from the one for the legacy SSB.

For one example, the initial condition for the SSS sequence for the on-demand SSB can be given by [x0(6) x0(5) x0(4) x0(3) x0(2) x0(1) x0(0)]≠[0000001], and/or [x1(6) x1(5) x1(4) x1(3) x1(2) x1(1) x1(0)]≠[0000001].

For yet another instance, the SSS sequence for the on-demand SSB can use a different mapping order comparing to the one for the legacy SSB.

For one example, the modulated value d_SSS(0) is mapped to subcarrier #182 in the SSS symbol within the on-demand SSB, d_SSS(1) is mapped to subcarrier #181 in the SSS symbol within the on-demand SSB, and so on, till d_SSS(126) is mapped to subcarrier #56 in the SSS symbol within the on-demand SSB (i.e., d_SSS(k) is mapped to subcarrier #182-k in the SSS symbol within the on-demand SSB, wherein 0≤k≤126).

In yet another example, the UE assumes the OFDM symbols that PSS and SSS are mapped into for the on-demand SSB can be different from the ones for the legacy SSB.

For one instance, the UE assumes the OFDM symbol mapped for PSS is the first OFDM symbol in the on-demand SSB and the OFDM symbol mapped for SSS is the second OFDM symbol in the on-demand SSB.

For another instance, the UE assumes the OFDM symbol mapped for SSS is the first OFDM symbol in the on-demand SSB and the OFDM symbol mapped for PSS is the second OFDM symbol in the on-demand SSB.

For yet another instance, the UE assumes the OFDM symbol mapped for PSS and SSS is the first OFDM symbol in the on-demand SSB.

In yet another example, the UE assumes the structure for the on-demand SSB can be different from the one for the legacy SSB (or periodically transmitted SSB).

For one instance, the UE assumes the on-demand SSB has a fewer number of OFDM symbols than the legacy SSB.

For one example, the on-demand SSB has 2 OFDM symbols and the legacy SSB has 4 OFDM symbols.

For another example, the on-demand SSB has 3 OFDM symbols and the legacy SSB has 4 OFDM symbols.

For yet another example, the on-demand SSB has 1 OFDM symbol and the legacy SSB has 4 OFDM symbols.

For another instance, the UE assumes the on-demand SSB has a larger number of OFDM symbols than the periodically transmitted SSB.

For one example, the on-demand SSB has 4 OFDM symbols and the periodically transmitted SSB has 1 OFDM symbol.

For another example, the on-demand SSB has 4 OFDM symbols and the periodically transmitted SSB has 2 OFDM symbols.

For yet another example, the on-demand SSB has 4 OFDM symbols and the periodically transmitted SSB has 3 OFDM symbols.

For yet another instance, the UE assumes the on-demand SSB has a larger bandwidth than 20 RBs.

For yet another instance, the UE assumes which structure is the on-demand SSB can be indicated to the UE by a gNB.

In yet another example, the UE assumes DM-RS for PBCH for the on-demand SSB can be different from the one for the legacy SSB.

For one instance, the UE assumes the initial condition for generating DM-RS sequence for PBCH for the on-demand SSB can be different from the one for legacy SSB.

For another instance, the UE assumes the mapping order for DM-RS sequence for PBCH for the on-demand SSB can be different from the one for legacy SSB. For one example, the mapping order can be reversed comparing to the mapping order for the legacy SSB. For another example, the mapping order can follow an order of time domain first and frequency domain second.

In yet another example, the UE assumes the payload of the PBCH (e.g., including MIB and/or physical layer bits included in the payload of the PBCH) for the on-demand SSB can be different from the one for the legacy SSB. For the instances of this example, when at least one bit in the PBCH payload is reserved, or reinterpreted, or absent, the UE can acquire the corresponding information associated with the at least one bit based on other method (e.g., from another cell, and/or indication by the gNB, and/or determined as a fixed value).

For one instance, the UE assumes at least one bit in the physical bits in PBCH payload (e.g., ā_{Ā}, ā_{Ā+1}, ā_{Ā+2}, ā_{Ā+3}, ā_{Ā+4}, ā_{Ā+5}, ā_{Ā+6}, ā_{Ā+7}, can be reserved for the on-demand SSB (e.g., setting the value to 0). For one example, the at least one bit can be from ā_{Ā}, ā_{Ā+1}, ā_{Ā+2}, ā_{Ā+3} for indicating the SFN information. For another example, the at least one bit can be ā_{Ā+4} for half frame indication. For yet another example, the at least one bit can be from ā_{Ā+5}, ā_{Ā+6}, ā_{Ā+7} for candidate SSB index indication (e.g., in FR2 and/or in FR1 unlicensed band).

For another instance, the UE assumes at least one bit in the physical bits in PBCH payload (e.g., ā_{Ā}, ā_{Ā+1}, ā_{Ā+2}, ā_{Ā+3}, ā_{Ā+4}, ā_{Ā+5}, ā_{Ā+6}, ā_{Ā+7}) can be reinterpreted for other purpose (e.g., other purpose can be according to example of this disclosure) and not used for indicating timing related information for on-demand SSB. For one example, the at least one bit can be from ā_{Ā}, ā_{Ā+1}, ā_{Ā+2}, ā_{Ā+3} for indicating the SFN information. For another example, the at least one bit can be ā_{Ā+4} for half frame indication. For yet another example, the at least one bit can be from ā_{Ā+5}, ā_{Ā+6}, ā_{Ā+7} for candidate SSB index indication (e.g., in FR2 and/or in FR1 unlicensed band).

For yet another instance, the UE assumes at least one bit in the physical bits in PBCH payload (e.g., ā_{Ā}, ā_{Ā+1}, ā_{Ā+2}, ā_{Ā+3}, ā_{Ā+4}, ā_{Ā+5}, ā_{Ā+6}, ā_{Ā+7}) can be absent for on-demand SSB (e.g., the payload size will be reduced). For one example, the at least one bit can be from ā_{Ā}, ā_{Ā+1}, ā_{Ā+2}, ā_{Ā+3} for indicating the SFN information. For another example, the at least one bit can be ā_{Ā+4} for half frame indication. For yet another example, the at least one bit can be from ā_{Ā+5}, ā_{Ā+6}, ā_{Ā+7} for candidate SSB index indication (e.g., in FR2 and/or in FR1 unlicensed band).

In such examples and instances, when at least one bit in the physical bits in PBCH payload (e.g., ā_{Ā}, ā_{Ā+1}, ā_{Ā+2}, ā_{Ā+3}, ā_{Ā+4}, ā_{Ā+5}, ā_{Ā+6}, ā_{Ā+7}) is reserved, or reinterpreted, or absent, the UE can assume its value is 0 for the on-demand SSB, or same as the one indicated by the legacy SSB, or provided by higher layer parameters from the gNB.

For one instance, the UE assumes at least one bit in SFN field in the MIB (e.g., systemFrameNumber) can be reserved for the on-demand SSB (e.g., setting the value to 0). For one example, the at least one bit can be the first X MSBs of the SFN field, wherein X is an integer, e.g., fixed or pre-defined. For another example, the at least one bit can be all the bits in the SFN field.

For another instance, the UE assumes at least one bit in SFN field in the MIB (e.g., systemFrameNumber) can be reinterpreted for other purpose (e.g., other purpose can be according to example of this disclosure) and not used for indicating SFN information for on-demand SSB. For one example, the at least one bit can be the first X MSBs of the SFN field, wherein X is an integer, e.g., fixed or pre-defined. For another example, the at least one bit can be all the bits in the SFN field.

For yet another instance, the UE assumes at least one bit in SFN field in the MIB (e.g., systemFrameNumber) can be absent for the on-demand SSB (e.g., MIB has a smaller number of bits). For one example, the at least one bit can be the first X MSBs of the SFN field, wherein X is an integer, e.g., fixed or pre-defined. For another example, the at least one bit can be all the bits in the SFN field.

For above instances, when at least one bit in SFN field in the MIB (e.g., systemFrameNumber) is reserved, or reinterpreted, or absent, the UE can assume its value is 0 for the on-demand SSB, or same as the one indicated by the legacy SSB, or provided by higher layer parameters from the gNB.

For one instance, the UE assumes the field for indicating the common subcarrier spacing in the MIB (e.g., subCarrierSpacingCommon) can be reserved for the on-demand SSB (e.g., setting the value to 0).

For another instance, the UE assumes the field for indicating the common subcarrier spacing in the MIB (e.g., subCarrierSpacingCommon) can be reinterpreted for other purpose (e.g., other purpose can be according to example of this disclosure) and not used for indicating common subcarrier spacing information for on-demand SSB.

For yet another instance, the UE assumes the field for indicating the common subcarrier spacing in the MIB (e.g., subCarrierSpacingCommon) can be absent for the on-demand SSB (e.g., MIB has fewer number of bits).

For above instances, when the field for common subcarrier spacing in the MIB (e.g., subCarrierSpacingCommon) is reserved, or reinterpreted, or absent, the UE can assume the SCS of CORESET #0 is same as the SCS of the on-demand SSB, or same as the one indicated by the legacy SSB, or provided by higher layer parameters from the gNB.

For one instance, the UE assumes at least one bit in the field for SSB's subcarrier offset in the MIB (e.g., ssb-SubcarrierOffset) can be reserved for the on-demand SSB (e.g., setting the value to 0).

For another instance, the UE assumes at least one bit in the field for SSB's subcarrier offset in the MIB (e.g., ssb-SubcarrierOffset) can be reinterpreted for other purpose (e.g., other purpose can be according to example of this disclosure) and not used for indicating the SSB's subcarrier offset for on-demand SSB.

For yet another instance, the UE assumes at least one bit in the field for SSB's subcarrier offset in the MIB (e.g., ssb-SubcarrierOffset) can be absent for the on-demand SSB (e.g., MIB has a smaller number of bits).

In such examples and instances, when at least one bit in the field for SSB's subcarrier offset in the MIB (e.g., ssb-SubcarrierOffset) is reserved, or reinterpreted, or absent, the UE can assume the value of k_SSB of the on-demand SSB is 0 or assume the value of k_SSB is same as the one indicated by the legacy SSB, or provided by higher layer parameters from the gNB.

For one instance, the UE assumes the field for indicating DM-RS position in the MIB (e.g., dmrs-TypeA-Position) can be reserved for the on-demand SSB (e.g., setting the value to 0).

For another instance, the UE assumes the field for indicating DM-RS position in the MIB (e.g., dmrs-TypeA-Position) can be reinterpreted for other purpose (e.g., other purpose can be according to example of this disclosure) and not used for indicating the DM-RS position for on-demand SSB.

For yet another instance, the UE assumes the field for indicating DM-RS position in the MIB (e.g., dmrs-TypeA-Position) can be absent for the on-demand SSB (e.g., MIB has a smaller number of bits).

For above instances, when the field for indicating DM-RS position in the MIB (e.g., dmrs-TypeA-Position) is reserved, or reinterpreted, or absent, the UE can assume the DM-RS position can be same as the one indicated by the legacy SSB, or provided by higher layer parameters from the gNB.

For one instance, the UE assumes at least one bit in the field for indicating the configuration of physical downlink control channel (PDCCH) for SIB1 in the MIB (e.g., pdcch-ConfigSIB1 including controlResourceSetZero and/or searchSpaceZero) can be reserved for the on-demand SSB (e.g., setting the value to 0).

For another instance, the UE assumes at least one bit in the field for indicating the configuration of PDCCH for SIB1 in the MIB (e.g., pdcch-ConfigSIB1 including controlResourceSetZero and/or searchSpaceZero) can be reinterpreted for other purpose (e.g., other purpose can be according to example of this disclosure) and not used for indicating the configuration of PDCCH for SIB1.

For yet another instance, the UE assumes at least one bit in the field for indicating the configuration of PDCCH for SIB1 in the MIB (e.g., pdcch-ConfigSIB1 including controlResourceSetZero and/or searchSpaceZero) can be absent for the on-demand SSB (e.g., MIB has a smaller number of bits).

In examples and instances disclosed in the present disclosure, when at least one bit in the field for indicating the confirmation of PDCCH for SIB1 in the MIB (e.g., pdcch-ConfigSIB1 including controlResourceSetZero and/or searchSpaceZero) is reserved, or reinterpreted, or absent, the UE can assume the confirmation of PDCCH for SIB1 can be same as the one indicated by the legacy SSB, or provided by higher layer parameters from the gNB.

For one instance, the UE assumes the field for indicating cell barring information in the MIB (e.g., cellBarred) can be reserved for the on-demand SSB (e.g., setting the value to 0).

For another instance, the UE assumes the field for indicating cell barring information in the MIB (e.g., cellBarred) can be reinterpreted for other purpose (e.g., other purpose can be according to example of this disclosure) and not used for indicating the cell barring information.

For yet another instance, the UE assumes the field for indicating cell barring information in the MIB (e.g., cellBarred) can be absent for the on-demand SSB (e.g., MIB has a smaller number of bits).

In examples and instances disclosed in the present disclosure, when the field for indicating cell barring information in the MIB (e.g., cellBarred) is reserved, or reinterpreted, or absent, the UE can assume the cell baring information can be same as the one indicated by the legacy SSB, or provided by higher layer parameters from the gNB.

For one instance, the UE assumes the field for indicating information for intra-frequency cell reselection in the MIB (e.g., intraFreqReselection) can be reserved for the on-demand SSB (e.g., setting the value to 0).

For another instance, the UE assumes the field for indicating information for intra-frequency cell reselection in the MIB (e.g., intraFreqReselection) can be reinterpreted for other purpose (e.g., other purpose can be according to example of this disclosure) and not used for information for intra-frequency cell reselection.

For yet another instance, the UE assumes the field for indicating information for intra-frequency cell reselection in the MIB (e.g., intraFreqReselection) can be absent for the on-demand SSB (e.g., MIB has a smaller number of bits).

In examples and instances disclosed in the present disclosure, when the field for indicating information for intra-frequency cell reselection in the MIB (e.g., intraFreqReselection) is reserved, or reinterpreted, or absent, the UE can assume the cell baring information can be same as the one indicated by the legacy SSB, or provided by higher layer parameters from the gNB.

For instances of this example wherein the at least one bit in PBCH payload can be reinterpreted for other purpose, the other purpose can be at least one from the following examples: 1) indicating the SSB is an on-demand SSB; 2) indicating the associated SIB1 is an on-demand SIB1; indicating a configuration for the PDCCH of the on-demand SIB1 (e.g., Type0-PDCCH); 3) indicating a subcarrier spacing for the PDCCH of the on-demand SIB1 (e.g., Type0-PDCCH); 4) indicating information on the frequency location of the on-demand SIB1 (e.g., subcarrier offset and/or RB offset from the SSB and/or absolute frequency location).

In yet another example, the UE assumes the use of reserved bit or codepoint in PBCH payload for the on-demand SSB can be different from the one for the legacy SSB.

For one instance, the UE assumes the spare bit in MIB (e.g., spare) can be used for indicating whether the SSB is an on-demand SSB and/or the associated SIB1 is an on-demand SIB1. Such as, when spare=1, the SSB is an on-demand SSB and/or the associated SIB1 is an on-demand SIB1.

For another instance, the UE assumes a reserved physical layer bit in PBCH payload (e.g., ā_{Ā+6} when L̅ₘₐₓ ≤10, and/or ā_{Ā+7} when L̅ₘₐₓ ≤8) can be used for indicating whether the SSB is an on-demand SSB and/or the associated SIB1 is an on-demand SIB1.

For yet another instance, the UE assumes a reserved codepoint of k_SSB (e.g., k_SSB determined based on PBCH payload) can be used for indicating whether the SSB is an on-demand SSB and/or the associated SIB1 is an on-demand SIB1. For one example, for FR1, when k_SSB=30, the SSB is an on-demand SSB and/or the associated SIB1 is an on-demand SIB1. For another example, for FR2, when k_SSB=14, the SSB is an on-demand SSB and/or the associated SIB1 is an on-demand SIB1. For this instance, when the reserved value of k_SSB is used for different purpose than the legacy SSB, the UE can assume the value of k_SSB of the on-demand SSB is 0, or assume the value of k_SSB is same as the one indicated by the legacy SSB, or provided by higher layer parameters from the gNB.

In yet another example, the UE assumes the number of REs mapped for PBCH (including data and/or DM-RS) for the on-demand SSB can be different from the one for the legacy SSB.

For one instance, the number of REs mapped for PBCH data can be smaller than 432.

For another instance, the number of REs mapped for PBCH DM-RS can be smaller than 144.

In yet another example, the UE assumes the time domain pattern of the on-demand SSB can be different from the one for the legacy SSB.

For one instance, the on-demand SSB can be transmitted in the candidate SSB occasions where the legacy SSB is not transmitted, e.g., the time domain pattern (e.g., indicated by a first bitmap or a first pair of bitmaps) for the on-demand SSB does not overlap with the time domain pattern (e.g., indicated by a second bitmap or a second pair of bitmaps) for the legacy SSB, or e.g., the indicated SSB index(es) for the on-demand SSB does not overlap with the indicated SSB index(es) for the legacy SSB.

For another instance, the QCL assumption for the transmission of on-demand SSB may be a subset of the one of the legacy SSB, e.g., the time domain pattern (e.g., indicated by a first bitmap or a first pair of bitmaps) for the on-demand SSB is a subset of the time domain pattern (e.g., indicated by a second bitmap or a second pair of bitmaps) for the legacy SSB, or e.g., the indicated SSB index(es) for the on-demand SSB is a subset of the indicated SSB index(es) for the legacy SSB.

In examples and instances disclosed in the present disclosure, the first bitmap can be with a length of maximum number of SSB in a half frame, and a bit taking a value of one indicates the corresponding SSB is actually transmitted.

In examples and instances disclosed in the present disclosure, the second bitmap can be with a length of maximum number of SSB in a half frame or of a number of actually transmitted SSB in a half frame, and a bit taking a value of one indicates the corresponding SSB is actually transmitted.

In examples and instances disclosed in the present disclosure, the first pair of bitmaps can include a first bitmap indicating actually transmitted group(s) of SSB, and a second bitmap indicating actually transmitted SSB(s) in a group.

In examples and instances disclosed in the present disclosure, the second pair of bitmaps can include a first bitmap indicating actually transmitted group(s) of SSB, and a second bitmap indicating actually transmitted SSB(s) in a group.

In another embodiment, at least one of the following examples can be the same for an on-demand SSB and a legacy SSB, e.g., when the UE is not using the at least one example to distinguish the on-demand SSB and the legacy SSB.

For one instance, a UE can assume the cell ID of the on-demand SSB and the legacy SSB is the same.

For another instance, a UE can assume the frequency location of the on-demand SSB and the legacy SSB is the same. For yet another instance, a UE can assume the subcarrier spacing of the on-demand SSB and the legacy SSB is the same.

For yet another instance, a UE can assume the PSS sequence and/or mapping method for the PSS sequence for the on-demand SSB and the legacy SSB is the same.

For yet another instance, a UE can assume the SSS sequence and/or mapping method for the SSS sequence for the on-demand SSB and the legacy SSB is the same.

For yet another instance, a UE can assume the SSB structure for the on-demand SSB and the legacy SSB is the same, e.g., both with 20 RBs and 4 OFDM symbols.

For yet another instance, a UE can assume the DM-RS sequence and/or mapping method for the DM-RS sequence for the on-demand SSB and the legacy SSB is the same.

For yet another instance, a UE can assume the fields in the PBCH payload other than timing related information are the same for the on-demand SSB and the legacy SSB.

For yet another instance, a UE can assume the time domain pattern of the transmission for the on-demand SSB is the same as the legacy SSB.

FIG. 8 illustrates a flowchart of UE method 800 for distinguishing on-demand SS/PBCH block according to embodiments of the present disclosure. The UE method 800 as may be performed by a UE (e.g., 111-116 as illustrated in FIG. 1). An embodiment of the UE method 800 shown in FIG. 8 is for illustration only. One or more of the components illustrated in FIG. 8 can be implemented in specialized circuitry configured to perform the noted functions or one or more of the components can be implemented by one or more processors executing instructions to perform the noted functions.

As illustrated in FIG. 8, the UE receives an SSB in step 801. In step 802, the UE determines whether the received SSB is an on-demand SSB or not. In step 803, the UE receives on-demand SIB1 if the received SSB is an on-demand SSB.

In one embodiment, a UE assumes a set of signals and/or channels can avoid collision with on-demand SSB.

In one example, a physical random access channel (PRACH) occasion in a PRACH slot is valid if it does not precede an on-demand SS/PBCH block in the PRACH slot and starts at least N_{gap} symbols after a last SS/PBCH block reception symbol in the on-demand SS/PBCH block.

In another example, a PUSCH occasion is valid if it does not precede an on-demand SS/PBCH block in the PUSCH slot and starts at least N_{gap} symbols after a last SS/PBCH block reception symbol in the on-demand SS/PBCH block.

In yet another example, a repetition of the PUSCH transmission does not include a symbol of an on-demand SS/PBCH block.

In yet another example, a UE assumes a symbol overlapping with an on-demand SS/PBCH block is a downlink symbol. For instance, for validation of uplink signal and/or channel, such as PUSCH (and/or its repetition), the uplink signal and/or channel overlapping with symbols for on-demand SS/PBCH block is not valid.

In yet another example, a UE does not expect a symbol overlapping with an on-demand SS/PBCH block to be indicated as uplink by higher layer parameters (e.g., tdd-UL-DL-ConfigurationCommon, or tdd-UL-DL-ConfigurationDedicated).

In yet another example, a UE does not expect a symbol overlapping with an on-demand SS/PBCH block to be indicated as uplink by a DCI format 2_0.

In yet another example, for monitoring a PDCCH candidate by a UE, if at least one RE for a PDCCH candidate overlaps with at least one RE of an on-demand SS/PBCH block, the UE is not required to monitor the PDCCH candidate.

In yet another example, the UE does not transmit PUSCH, PUCCH, or PRACH in a slot, if the transmission may overlap with any symbol in an on-demand SS/PBCH block.

In yet another example, the UE does not transmit SRS in a set of symbols in a slot, if the transmission may overlap with any symbol in an on-demand SS/PBCH block.

In yet another example, when receiving PDSCH, e.g., the PDSCH is scheduled by PDCCH with CRC scrambled by SI-RNTI (and the system information indicator in DCI is set to 0), the UE assumes no on-demand SS/PBCH block is transmitted in the REs used for a reception of the PDSCH.

In yet another example, when receiving PDSCH, e.g., the PDSCH is scheduled by PDCCH with CRC scrambled by SI-RNTI (and the system information indicator in DCI is set to 1), RA-RNTI, MSGB-RNTI, P-RNTI or TC-RNTI, if the PDSCH resource allocation overlaps with PRBs containing on-demand SS/PBCH block transmission resource, the UE assumes that the PRBs containing on-demand SS/PBCH block transmission resource are not available for PDSCH resource in the symbols where the on-demand SS/PBCH block is transmitted.

In yet another example, when receiving PDSCH, e.g., the PDSCH is scheduled by PDCCH with CRC scrambled by C-RNTI, MCS-C-RNTI, CS-RNTI, G-RNTI, G-CS-RNTI, or MCCH-RNTI, or the PDSCH is SPS, if the PDSCH resource allocation overlaps with PRBs containing on-demand SS/PBCH block transmission resource, the UE assumes that the PRBs containing on-demand SS/PBCH block transmission resource are not available for PDSCH resource in the symbols where the on-demand SS/PBCH block is transmitted.

In one embodiment, a UE assumes a set of signals and/or channels may not avoid collision with on-demand SS/PBCH block.

In one example, a PRACH occasion in a PRACH slot is valid regardless of the transmission of on-demand SS/PBCH block in the PRACH slot and/or partially in the PRACH slot.

In another example, a PUSCH occasion is valid regardless of the transmission of on-demand SS/PBCH block in the PRACH slot and/or partially in the PRACH slot.

In yet another example, a repetition of the PUSCH transmission can include a symbol of an on-demand SS/PBCH block.

In yet another example, a UE assumes a symbol overlapping with an on-demand SS/PBCH block can be indicated as uplink by higher layer parameters (e.g., tdd-UL-DL-ConfigurationCommon, or tdd-UL-DL-ConfigurationDedicated).

In yet another example, a UE assumes a symbol overlapping with an on-demand SS/PBCH block can be indicated as uplink by a DCI format 2_0.

In yet another example, for monitoring a PDCCH candidate by a UE, if at least one RE for a PDCCH candidate overlaps with at least one RE of an on-demand SS/PBCH block, the UE may still need to monitor the PDCCH candidate.

In yet another example, the UE may transmit PUSCH, PUCCH, or PRACH in a slot, if the transmission may overlap with any symbol in an on-demand SS/PBCH block.

In yet another example, the UE may transmit SRS in a set of symbols in a slot, if the transmission may overlap with any symbol in an on-demand SS/PBCH block.

In yet another example, when receiving PDSCH, e.g., the PDSCH is scheduled by PDCCH with CRC scrambled by SI-RNTI (and the system information indicator in DCI is set to 0), the UE assumes on-demand SS/PBCH block can be transmitted in the REs used for a reception of the PDSCH.

In yet another example, when receiving PDSCH, e.g., the PDSCH is scheduled by PDCCH with CRC scrambled by SI-RNTI (and the system information indicator in DCI is set to 1), RA-RNTI, MSGB-RNTI, P-RNTI or TC-RNTI, if the PDSCH resource allocation overlaps with PRBs containing on-demand SS/PBCH block transmission resource, the UE assumes that the PRBs containing on-demand SS/PBCH block transmission resource can be available for PDSCH resource in the symbols where the on-demand SS/PBCH block is transmitted.

In yet another example, when receiving PDSCH, e.g., the PDSCH is scheduled by PDCCH with CRC scrambled by C-RNTI, MCS-C-RNTI, CS-RNTI, G-RNTI, G-CS-RNTI, or MCCH-RNTI, or the PDSCH is SPS, if the PDSCH resource allocation overlaps with PRBs containing on-demand SS/PBCH block transmission resource, the UE assumes that the PRBs containing on-demand SS/PBCH block transmission resource can be available for PDSCH resource in the symbols where the on-demand SS/PBCH block is transmitted.

In yet another example, when receiving a legacy SS/PBCH block (e.g., a periodic SS/PBCH block) and/or an on-demand SS/PBCH block, the UE assumes the time (e.g., OFDM symbols) and/or frequency (e.g., REs or RBs or subcarriers) resources of the legacy SS/PBCH block do not overlap the time (e.g., OFDM symbols) and/or frequency (e.g., REs or RBs or subcarriers) resources of the on-demand SS/PBCH block. For instance, if the time (e.g., OFDM symbols) and/or frequency (e.g., REs or RBs or subcarriers) resources overlap, the UE can stop receiving the legacy SS/PBCH block (e.g., a periodic SS/PBCH block) and/or an on-demand SS/PBCH block.

In one embodiment, the UE is aware of the on-demand SS/PBCH block by explicit signalling from a gNB.

For one example, the transmission of the on-demand SS/PBCH block can be indicated to the UE by the DL trigger for the on-demand SS/PBCH block, and the UE applies example behaviour to avoid collision with on-demand SS/PBCH block (e.g., according to example in this disclosure) if the UE receives the DL trigger; and the UE may not apply behaviour to avoid collision with on-demand SS/PBCH block (e.g., according to example in this disclosure) if the UE does not receive the DL trigger.

For another example, the candidate resources for the on-demand SS/PBCH block can be indicated to the UE by higher layer parameters and/or fixed in the specification, and the UE applies example behaviour to avoid collision with the candidate resources for the on-demand SS/PBCH block (e.g., according to example in this disclosure) after receiving the higher layer parameters.

For yet another example, the candidate resources for the on-demand SS/PBCH block can be indicated to the UE by higher layer parameters and/or fixed in the specification, and the transmission of the on-demand SS/PBCH block in all or a subset of the resources can be indicated to the UE by the DL trigger for the on-demand SS/PBCH block, and the UE applies example behaviour to avoid collision with on-demand SS/PBCH block (e.g., according to example in this disclosure) if the UE receives the DL trigger; and the UE may not apply behaviour to avoid collision with on-demand

SS/PBCH block (e.g., according to example in this disclosure) if the UE does not receive the DL trigger.

For yet another example, the candidate resources for the on-demand SS/PBCH block can be indicated to the UE by higher layer parameters and/or fixed in the specification, and the transmission of the on-demand SS/PBCH block in all or a subset of the candidate resources can be indicated to the UE by the DL trigger for the on-demand SS/PBCH block, and the UE applies example behaviour to avoid collision with transmitted on-demand SS/PBCH block (e.g., according to example in this disclosure) if the UE receives the DL trigger; and the UE may not apply behaviour to avoid collision with all candidate resources for the on-demand SS/PBCH block (e.g., according to example in this disclosure) if the UE does not receive the DL trigger.

In one examples and instances disclosed in present disclosure, the DL trigger can be a DCI format that includes a field indicating the transmission of on-demand SS/PBCH block.

For one example, a DCI format scheduling PDSCH(s) can indicate whether and/or which on-demand SS/PBCH block is transmitted in the candidate resources that PDSCH(s) is scheduled, and the UE assumes that the PRBs containing on-demand SS/PBCH block transmission resource are not available for PDSCH resource in the symbols where the on-demand SS/PBCH block is transmitted.

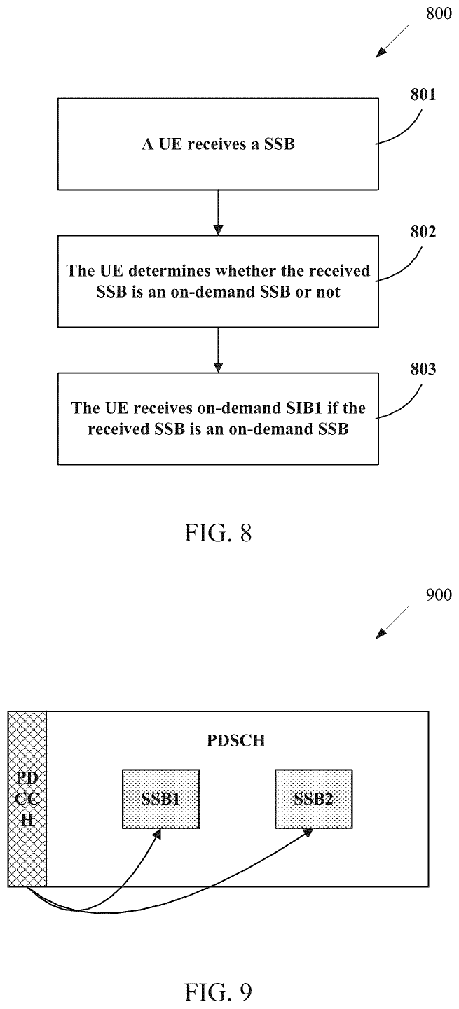

FIG. 9 illustrates an example of on-demand SSB indication in DCI 900 according to embodiments of the present disclosure. An embodiment of the on-demand SSB indication in DCI 900 shown in FIG. 9 is for illustration only.

For another example, a DCI format scheduling PUSCH(s) can indicate whether and/or which on-demand SS/PBCH block is transmitted in the candidate resources that PUSCH(s) is scheduled, and the UE assumes that the symbols containing on-demand SS/PBCH block transmission resource are not available for PUSCH resource.

For yet another example, a DCI format can indicate whether and/or which on-demand SS/PBCH block is transmitted in the candidate resources for the on-demand SS/PBCH block, and the UE can apply example behaviour to avoid collision with transmitted on-demand SS/PBCH block (e.g., according to example in this disclosure) after receiving the DCI format.

For one instance, the indication in the DCI format can be a bitmap, wherein each of the bit in the bitmap corresponds to a candidate transmission for an on-demand SS/PBCH block. The bit taking value of 1 indicates the corresponding on-demand SS/PBCH block is actually transmitted, and the bit taking value of 0 indicates the corresponding on-demand SS/PBCH block is not actually transmitted.

For one example, the bitmap has a length of 2 and corresponds to 2 candidate SS/PBCH block occasions in a slot.

For another example, the bitmap has a length of 2*L, wherein L is the number of slots in which the resource allocation for the concerned channel is performed, and the bitmap corresponds to 2*L candidate SS/PBCH block occasions in the L slots.

For yet another example, the bitmap has a length of L′, wherein L′ is the number of candidate SS/PBCH block occasions that overlap with the resource allocation for the concerned channel, and the bitmap corresponds to L′ candidate SS/PBCH block occasions.

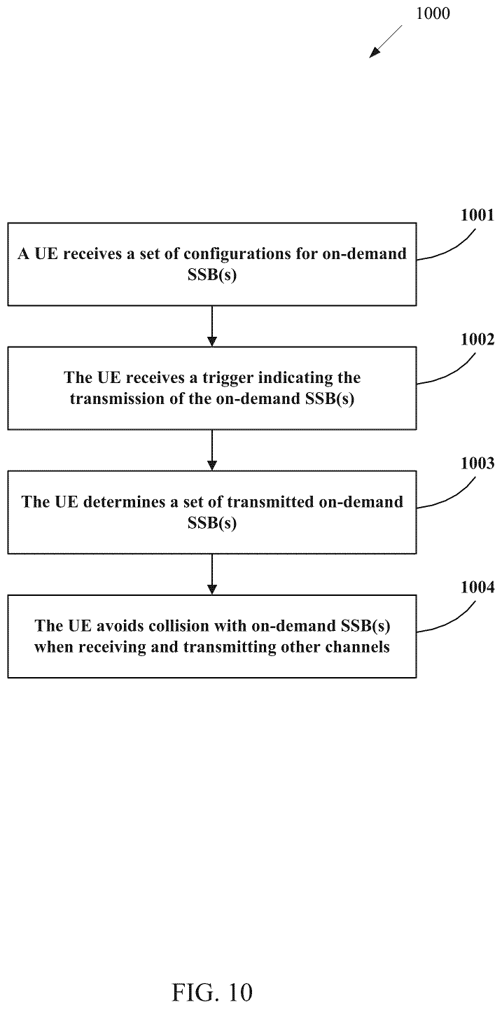

FIG. 10 illustrates a flowchart of UE method 1000 for handling collision with on-demand SSB(s). according to embodiments of the present disclosure. The UE method 1000 as may be performed by a UE (e.g., 111-116 as illustrated in FIG. 1). An embodiment of the UE method 1000 shown in FIG. 10 is for illustration only. One or more of the components illustrated in FIG. 10 can be implemented in specialized circuitry configured to perform the noted functions or one or more of the components can be implemented by one or more processors executing instructions to perform the noted functions.

In one embodiment, an example UE procedure for avoiding collision with on-demand SS/PBCH block is shown in FIG. 10.

As illustrated in FIG. 10, in step 1001, a UE receives a set of configurations for on-demand SSB(s). In step 1002, the UE receives a trigger indicating the transmission of the on-demand SSB(s). In step 1003, the UE determines a set of transmitted on-demand SSB(s). In step 1004, the UE avoids collision with on-demand SSB(s) when receiving and transmitting other channels.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a processor configured to:
determine a first set of parameters for a first set of synchronization signals and physical broadcast channel (SS/PBCH) blocks, wherein the first set of parameters includes a first cell identity (ID) and a first frequency location; and
determine a second set of parameters for a second set of SS/PBCH blocks, wherein the second set of parameters includes a second cell ID and a second frequency location and wherein:
the first set of SS/PBCH blocks is periodic,
the second set of SS/PBCH blocks is on-demand and indicated to be transmitted by a base station (BS),
the first cell ID is different from the second cell ID, and
the first frequency location is different from the second frequency location; and
a transceiver operably coupled to the processor, the transceiver configured to:
receive a first SS/PBCH block from the first set of SS/PBCH blocks; and
receive a second SS/PBCH block from the second set of SS/PBCH blocks.

2. The UE of claim 1, wherein the second frequency location does not correspond to a synchronization raster entry.

3. The UE of claim 1, wherein the processor is further configured to:
determine that resources of the first SS/PBCH block are 4 orthogonal frequency division multiplexing (OFDM) symbols in a time domain and 20 resource blocks (RBs) in a frequency domain;
determine that resources of the second SS/PBCH block are 4 OFDM symbols in the time domain and 20 RBs in the frequency domain; and
determine that the resources of the first SS/PBCH block and the resources of the second SS/PBCH block do not overlap.

4. The UE of claim 1, wherein the processor is further configured to:
determine a first time domain pattern for the first set of SS/PBCH blocks; and
determine a second time domain pattern for the second set of SS/PBCH blocks, wherein:
the first time domain pattern and the second time domain pattern indicate transmitted SS/PBCH blocks in a burst, and
the second time domain pattern is same as or a subset of the first time domain pattern.

5. The UE of claim 1, wherein the processor is further configured to determine an orthogonal frequency division multiplexing (OFDM) symbol as a downlink symbol when the OFDM symbol overlaps with a SS/PBCH block in the second set of SS/PBCH blocks.

6. The UE of claim 1, wherein the processor is further configured to determine not to monitor a physical downlink control channel (PDCCH) candidate when at least one resource element (RE) for the PDCCH candidate overlaps with at least one RE of a SS/PBCH block in the second set of SS/PBCH blocks.

7. The UE of claim 1, wherein the processor is further configured to determine a physical random access channel (PRACH) occasion in a PRACH slot as valid when:
the PRACH occasion does not precede a SS/PBCH block in the second set of SS/PBCH blocks in the PRACH slot; and
the PRACH occasion starts N_{gap} orthogonal frequency division multiplexing (OFDM) symbols after a last OFDM symbol of the SS/PBCH block.

8. A method of a user equipment (UE) in a wireless communication system, the method comprising:
determining a first set of parameters for a first set of synchronization signals and physical broadcast channel (SS/PBCH) blocks, wherein the first set of parameters includes a first cell identity (ID) and a first frequency location;
determining a second set of parameters for a second set of SS/PBCH blocks, wherein the second set of parameters includes a second cell ID and a second frequency location and wherein:
the first set of SS/PBCH blocks is periodic,
the second set of SS/PBCH blocks is on-demand and indicated to be transmitted by a base station (BS),
the first cell ID is different from the second cell ID, and
the first frequency location is different from the second frequency location;
receiving a first SS/PBCH block from the first set of SS/PBCH blocks; and
receiving a second SS/PBCH block from the second set of SS/PBCH blocks.

9. The method of claim 8, wherein the second frequency location does not correspond to a synchronization raster entry.

10. The method of claim 8, further comprising:
determining that resources of the first SS/PBCH block are 4 orthogonal frequency division multiplexing (OFDM) symbols in a time domain and 20 resource blocks (RBs) in a frequency domain;
determining that resources of the second SS/PBCH block are 4 OFDM symbols in the time domain and 20 RBs in the frequency domain; and
determining that the resources of the first SS/PBCH block and the resources of the second SS/PBCH block do not overlap.

11. The method of claim 8, further comprising:
determining a first time domain pattern for the first set of SS/PBCH blocks; and
determining a second time domain pattern for the second set of SS/PBCH blocks, wherein:
the first time domain pattern and the second time domain pattern indicate transmitted SS/PBCH blocks in a burst, and
the second time domain pattern is same as or a subset of the first time domain pattern.

12. The method of claim 8, further comprising:
determining an orthogonal frequency division multiplexing (OFDM) symbol as a downlink symbol when the OFDM symbol overlaps with a SS/PBCH block in the second set of SS/PBCH blocks.

13. The method of claim 8, further comprising:
determining not to monitor a physical downlink control channel (PDCCH) candidate when at least one resource element (RE) for the PDCCH candidate overlaps with at least one RE of a SS/PBCH block in the second set of SS/PBCH blocks.

14. The method of claim 8, further comprising:
determining a physical random access channel (PRACH) occasion in a PRACH slot as valid when:
the PRACH occasion does not precede a SS/PBCH block in the second set of SS/PBCH blocks in the PRACH slot; and
the PRACH occasion starts N_{gap} orthogonal frequency division multiplexing (OFDM) symbols after a last OFDM symbol of the SS/PBCH block.

15. A base station (BS) in a wireless communication system, the BS comprising:
a processor configured to:
determine a first set of parameters for a first set of synchronization signals and physical broadcast channel (SS/PBCH) blocks, wherein the first set of parameters includes a first cell identity (ID) and a first frequency location; and
determine a second set of parameters for a second set of SS/PBCH blocks, wherein the second set of parameters includes a second cell ID and a second frequency location and wherein:
the first set of SS/PBCH blocks is periodic,
the second set of SS/PBCH blocks is on-demand,
the first cell ID is different from the second cell ID, and
the first frequency location is different from the second frequency location; and
a transceiver operably coupled to the processor, the transceiver configured to transmit the first and second set of SS/PBCH blocks.

16. The BS of claim 15, wherein the second frequency location does not correspond to a synchronization raster entry.

17. The BS of claim 15, wherein the processor is further configured to:
determine that resources of a first SS/PBCH block in the first set of SS/PBCH blocks are 4 orthogonal frequency division multiplexing (OFDM) symbols in a time domain and 20 resource blocks (RBs) in a frequency domain;
determine that resources of a second SS/PBCH block in the second set of SS/PBCH blocks are 4 OFDM symbols in the time domain and 20 RBs in the frequency domain; and
determine that the resources of the first SS/PBCH block and the resources of the second SS/PBCH block do not overlap.

18. The BS of claim 15, wherein the processor is further configured to:
determine a first time domain pattern for the first set of SS/PBCH blocks; and
determine a second time domain pattern for the second set of SS/PBCH blocks, wherein:
the first time domain pattern and the second time domain pattern indicate transmitted SS/PBCH blocks in a burst, and
the second time domain pattern is same as or a subset of the first time domain pattern.

19. The BS of claim 15, wherein the processor is further configured to determine an orthogonal frequency division multiplexing (OFDM) symbol as a downlink symbol when the OFDM symbol overlaps with a SS/PBCH block in the second set of SS/PBCH blocks.

20. The BS of claim 15, wherein the processor is further configured to determine a physical random access channel (PRACH) occasion in a PRACH slot as valid when:
the PRACH occasion does not precede a SS/PBCH block in the second set of SS/PBCH blocks in the PRACH slot; and
the PRACH occasion starts N_{gap} orthogonal frequency division multiplexing (OFDM) symbols after a last OFDM symbol of the SS/PBCH block.
